(19) United States
(12) Patent Application Publication
(10) Pub. No.: US 2026/0285623 A1
(43) Pub. Date: Sep. 24, 2026

(54) A singularized blister unloading system

(71) Applicant: MARCHESINI GROUP S.P.A., Pianoro, BOLOGNA (IT)

(72) Inventor: Simone NANNETTI, Pianoro, BOLOGNA (IT)

(21) Appl. No.: 19/475,479

(22) PCT Filed: Mar. 22, 2024
(86) PCT No.: PCT/IB2024/052749

§ 371 Date: Oct. 15, 2025

(30) Foreign Application Priority Data
Jun. 28, 2023 (IT) 102023000013407

(51) Int. Cl. B65G 59/06; B65B 35/02

(52) U.S. Cl. CPC B65G 59/062; B65B 35/02; B65G 2201/0235; B65G 2814/0308

(57) ABSTRACT

The invention is an unloading system (1) suitable for performing a singularized unloading operation of a blister (90), comprising: i) a blister storage column (2) that extends along a vertical axis (V-V) in which a column of blisters (900) comprising a plurality of blisters (90) that are vertically stacked, each parallel to a respective imaginary plane, is housable, wherein the blister storage column (2) comprises a bottom region (20) in which the column of blisters (900) comprises a last blister (90a) and a second-last blister (90b); ii) a pair of unloading assemblies (3) that extend and operate transversely opposed with respect to the vertical axis (V-V), wherein each unloading assembly (3) comprises:—a plurality of blade groups (4) transversely movable along a transverse axis (X-X), each suitable for engaging a respective blister (90) starting from the last blister (90a) and the second-last blister (90b), wherein each blade group (4) comprises a movement device (412, 422) and a blade element (411, 421) suitable for engaging a blister and engaged with an end of the respective movement device (412, 422);—a control group (5) operatively connected to the respective end of the movement devices (412, 422), comprising a cam device (50) which transversely moves the movement devices (412, 422) alternately in such a way that, in two vertically consecutive blade groups (4), a blade element (411, 421) is disengaged from a blister which is thus free to fall vertically, while the other blade element (411, 421) engages and holds the next blister in a respective vertical axial position and vice versa.

### DESCRIPTION

The present invention relates to an unloading system suitable for performing a singularized unloading operation of a blister. Additionally, the present invention relates to a blister packaging machine that comprises said unloading system.

Known in the prior art are blister packaging machines that are suitable for performing a series of operations to produce blisters and possibly enclosing and/or boxing blisters in cartons or boxes. Specifically, “blisters” are those packages that, within special alveoli, contain specific products, for example pharmaceutical type products such as capsules, tablets or similar products. The definition “blister” in this discussion is not limited to the type of products contained within the respective alveoli which may, for example, contain syringes, vials etc.

Specifically, known blister packaging machines comprise a station comprising an unloading system that is suitable unloading a singularized blister onto a conveyor belt.

Preferably, in known unloading systems, there is included an accumulation system and specific unloading assemblies that are suitable for controlling the movement, or for enabling the movement, of a blister towards the conveyor belt.

Unloading systems are known which use rotating unloading assemblies in which the blister is unloaded at a specific angular position, whilst at other angular positions the blister is held in position.

Such unloading systems present various issues: they require the correct positioning of the blister, which instead may not always be ensured, which may result in the blister being, for example, inclined or bent, occasionally causing the unloading system to become blocked; these are systems of limited versatility that are suitable for operating with specific types of blister and not with a multiplicity of blisters of varying shapes and dimensions.

Furthermore, unloading systems are known which have unloading assemblies comprising pneumatic manipulators that are suitable for picking up a blister and unloading it to a preferred location and in a preferred way. These solutions are more versatile but are extremely complex both as regards the implementation and management thereof.

The object of the present invention is that of effectively resolving the aforesaid situation by proposing an unloading system that is suitable for performing a singularized unloading operation of a blister that avoids the aforesaid issues. In other words, the object of the present invention is that of providing an unloading system with a simple geometry, simple management and elevated flexibility that is suitable for performing singularized unloading operations of blisters that are reliable and safe.

This object is achieved by means of the unloading system claimed in claim 1. Additionally, this object is achieved by the blister packaging machine according to claim 12. The claims dependent on these request protection for further features and entail further technical benefits.

In addition, further features and advantages of the invention will become clear from the description provided below of the preferred embodiments thereof given as non-limiting examples in reference to the attached figures, wherein:

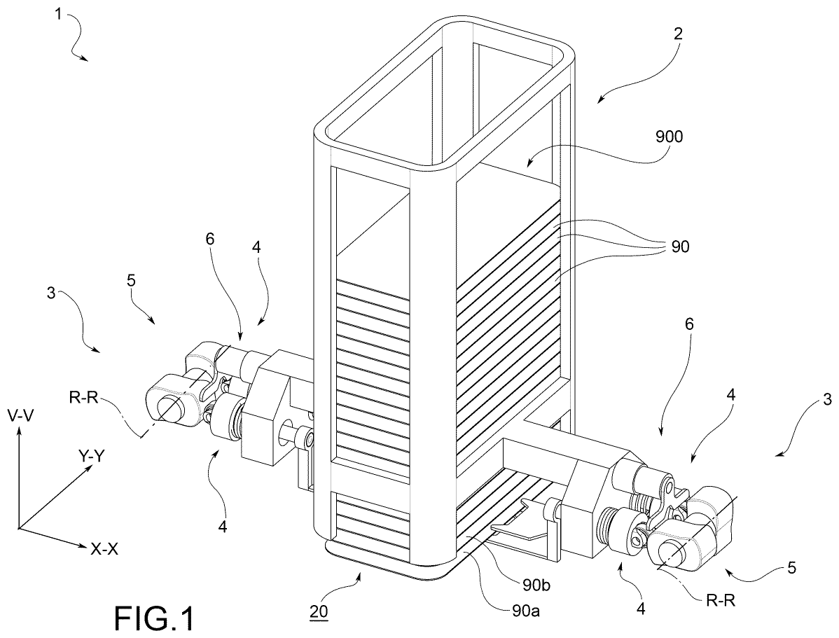

FIG. 1 shows a perspective view of an unloading system according to the present invention, in accordance with a first embodiment;

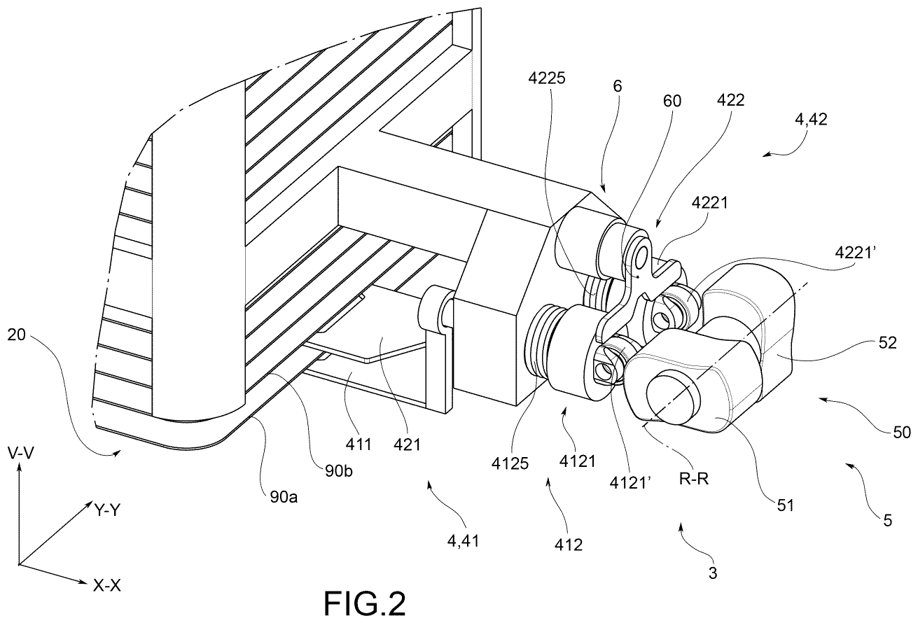

FIG. 2 is an enlarged view of a portion of FIG. 1;

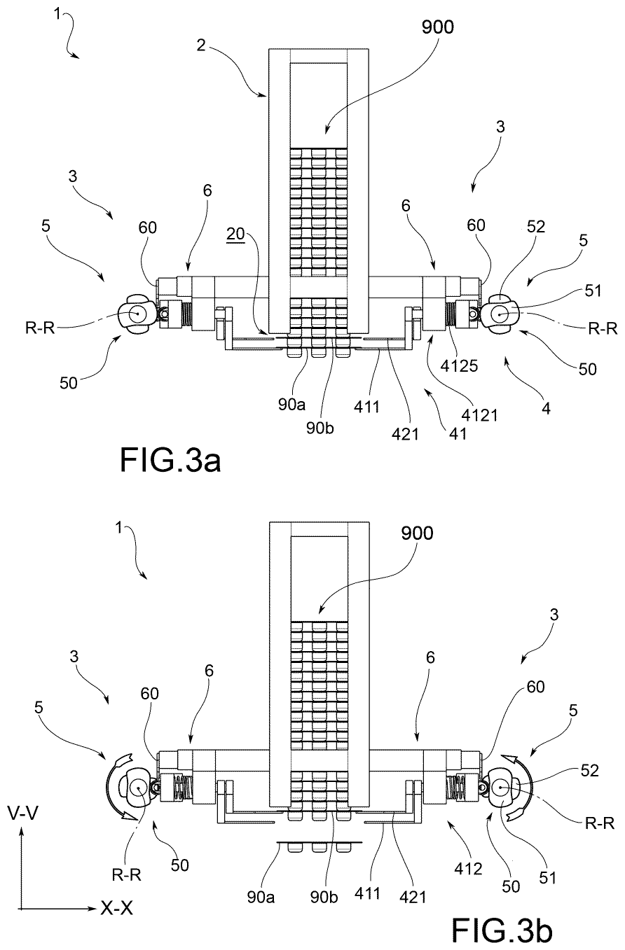

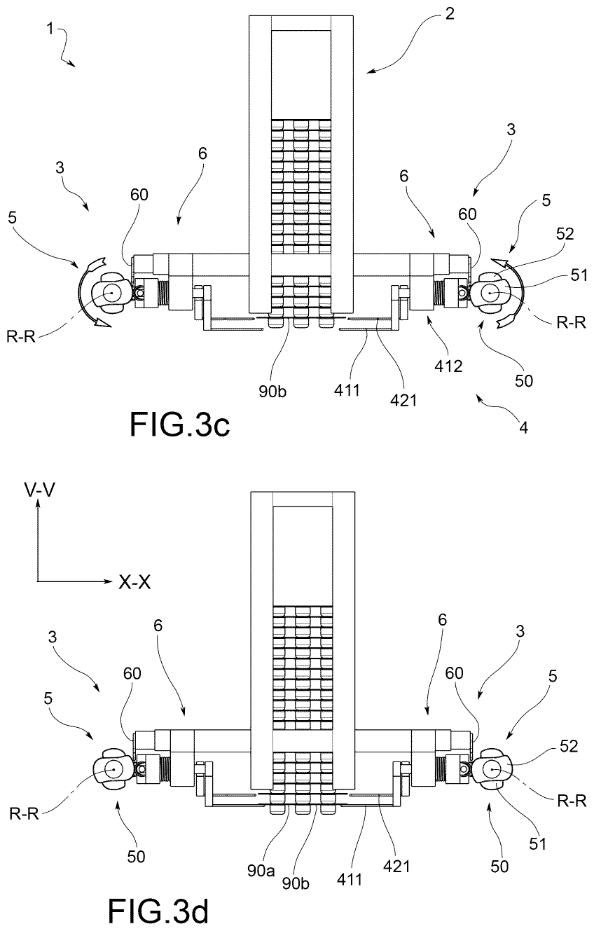

FIGS. 3a, 3b, 3c and 3d show, respectively, front views of the unloading system of FIG. 1, representing the steps of a blister unloading cycle;

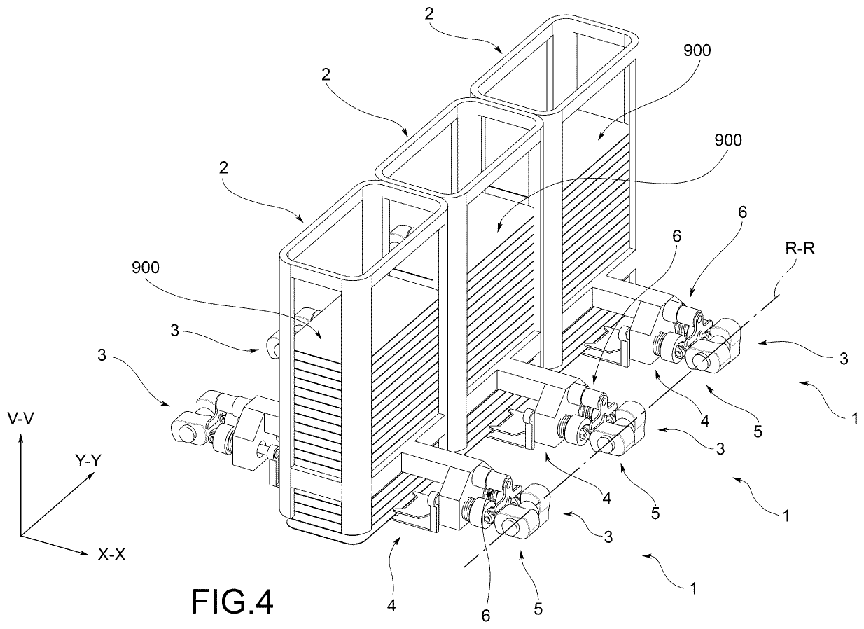

FIG. 4 shows a portion of a blister packaging machine that comprises a plurality of unloading systems in parallel.

In the accompanying figures, the reference numeral 1 shows an unloading system according to the present invention.

The unloading system 1 is suitable for performing a singularized unloading operation of a blister 90, for example onto a conveyor belt. The unloading system 1 is suitable for performing a multiplicity of singularized unloading operations of blisters 90, for example onto a conveyor belt, continuously.

As a matter of fact, the unloading system 1 comprises a blister storage column 2 and a pair of unloading assemblies 3 operating in a bottom region of said blister storage column 2.

The blister storage column 2 extends along a vertical axis V-V and houses a column of blisters 900 comprising a plurality of blisters 90 that are vertically stacked, each parallel to a respective imaginary plane.

As mentioned, the blister storage column 2 comprises a bottom region 20 that is substantially open and, within the column of blisters 900, there is a last blister 90a and a second-last blister 90b at said bottom region 20.

Preferably, therefore, the column of blisters 900 is suitable for being lowered, typically by means of the force of gravity, along the vertical axis V-V, within the blister storage column 2, corresponding with the unloading of a blister, in particular the last blister 90a, the position of which is taken by the second-last blister 90b.

In further other words, within the bottom region 20 there is a bottom area in which the last blister 90a is housed, and a pre-bottom area in which the second-last blister 90b is housed.

According to a preferred embodiment, the blister storage column 2 has a cross-section that is substantially complementary to the blister 90. In other words, the walls of the blister storage column 2 are suitable for keeping the blisters 90 belonging to the column of blisters 900 vertically stacked.

As mentioned, the unloading system 1 comprises a pair of unloading assemblies 3 that extend and operate transversely opposed with respect to the vertical axis V-V. In other words, the two unloading assemblies 3 are reciprocally separated by the blister storage column 2 and by the column of blisters 900. In other words, the two unloading assemblies 3 are one on one side, for example to the right, and the other on the other side, for example to the left. Preferably, the two unloading assemblies 3 mirror one another in relation to the vertical axis V-V.

According to a preferred embodiment, each unloading assembly 3 extends and operates along a transverse axis X-X.

According to a preferred embodiment, the two unloading assemblies 3 extend and operate along the same transverse axis X-X.

According to the present invention, each unloading assembly 3 comprises a blade group 4 and a control group 5 operatively connected to the blade group 4 in order to move it transversely.

According to the present invention, each unloading assembly 3 comprises a plurality of blade groups 4 and a control group 5 operatively connected to the blade groups 4 in order to move them transversely.

Preferably, each unloading assembly 3 also comprises a safety group 6.

According to the present invention, each blade group 4 is transversely movable along a transverse axis X-X.

Each blade group 4 is suitable for engaging with a respective blister 90 starting from the last blister 90a and from the second-last blister 90b.

According to a preferred embodiment, the plurality of blade groups 4 comprises two blade groups 41, 42, of which one is suitable for engaging with the last blister 90a and the other is suitable for engaging with the second-last blister 90b.

In other words, the plurality of blade groups 4 comprises two blade groups 41, 42, of which one operates within the bottom area whilst the other operates within the pre-bottom area.

According to a preferred embodiment, the plurality of blade groups 4 comprises only two blade groups 41, 42.

According to the invention, the blade group 4 comprises a movement device 412, 422 and a blade element 411, 421.

Preferably, the movement device 412, 422 is engaged at one end by the blade element 411, 412 and at the other end by the control group 5.

According to a preferred embodiment, the blade element 411, 412 is suitable for engaging with the respective blister 90. For example, each blade group is specially shaped to engage with the respective blister pack, for example it is shaped to insert into, and not collide with, the blister alveoli.

According to a preferred embodiment, the translatory movement of the movement device 412, 422 corresponds to a translatory movement of the blade element 411, 421.

According to the present invention, the control group 5 comprises a cam device 50 that transversely moves the movement device 412, 422 that is operatively connected thereto.

According to the present invention, the control group 5 comprises a cam device 50 that transversely moves the movement device 412, 422. In particular, the cam device 50 transversely moves the movement device 412, 422 in an alternating motion.

According to the present invention, the control group 5 comprises a cam device 50 that transversely moves the movement devices 412, 422 alternately, in such a way that, in two vertically consecutive blade groups 4, one blade element 411, 421 is disengaged from a blister that is thus free to fall vertically, whilst the other blade element 411, 421 engages and holds the consecutive blister in a respective vertical axial position and vice versa.

According to a preferred embodiment, the pair of unloading assemblies 3 is configurable in a blister unloading configuration, in which the last blister 90a is free to fall while the second-last blister 90b is held in a respective vertical axial position, and a blister holding configuration, in which the last blister 90a is held in a respective vertical axial position while the second-last blister 90b is free to fall.

In other words, the unloading system 1 that is the object of the present invention operates in such a way as to enable the falling movement of a blister, blocking the consecutive blister. That is to say that the unloading system 1 enables the movement and unloading of the last blister 90a whilst holding the second-last blister 90b in position. Once the last blister 90a has been unloaded, the movement of the second-last blister 90b is enabled, which in turn becomes the last-blister 90a, i.e., it passes from the pre-bottom area to the bottom area.

In other further words, the movement of the blisters is controlled and performed by steps.

According to a preferred embodiment, the movement device 412, 422 (in particular each movement device) comprises a rod element 4121, 4221 comprising a first end that is integrally connected to the blade element 411, 421 and a second end that is engageable with the cam device 50 in order to receive the transverse thrust action.

Preferably, the rod element 4121, 4221 comprises a wheel member 4121′, 4221′ suitable for engaging with the cam device 50.

According to a preferred embodiment, the movement device 412, 422 (in particular each movement device) comprises an elastically yielding element 4125, 4225 that is suitable for performing a transverse thrust action upon the rod element 4121, 4221 in order to keep it engaged with the cam device 50.

Preferably, said elastically yielding element 4125, 4225 is a helical spring fitted onto the rod element 4121, 4221.

According to a preferred embodiment, the cam device 50 comprises a single cam profile that is suitable for alternately moving each movement device 412, 422.

According to a preferred embodiment, the cam device 50 comprises a plurality of cam members 51, 52 each operatively connected to the respective movement device 412, 422, wherein the respective cam profiles are suitable for alternately moving the movement devices 412, 422.

According to a preferred embodiment, the cam members 51, 52 are controlled in rotation in relation to the same axis of rotation R-R.

According to a preferred embodiment, the two control groups 5, each of a respective unloading assembly 3, operate synchronously on the respective blade groups 4 by means of a drive element suitable for connecting them, such as a belt or chain. In other words, according to a preferred embodiment, the unloading system 1 comprises a transmission element that connects the control groups 5 of the two unloading assemblies 3.

According to preferred embodiment, each unloading assembly 3 comprises a safety group 6 suitable for disengaging the blade group 4 from the control group 5 in order to position it in a fixed transverse position in which it engages with the blister.

The safety group 6 is preferably suitable for disengaging the blade group 4 from the control group 5, inhibiting the latter from the possibility of moving the blade group 4, positioning said blade group 4 in a fixed advanced position in which it engages with the blister.

According to preferred embodiment, each unloading assembly 3 comprises a safety group 6 suitable for disengaging at least one blade group 4, preferably the blade group that operates on the last blister 90a, from the control group 5 in order to position said blade group 4 in a fixed advanced transverse position in which it engages with the blister.

The safety group 6 is preferably suitable for disengaging the blade groups 4 from the control group 5, inhibiting the latter from the possibility of moving the blade groups 4, positioning said blade groups 4 in a fixed advanced position in which each engages with the respective blister.

In other words, the safety group 6 disengages the blade groups 4 from the control group 5, which is therefore prevented from moving them in translation.

Preferably, said safety group 6 comprises a lever element 60 placeable in a safety position in which the action of the elastically yielding element 4125, 4225 is overcome so as to transversely move the rod element 4121, 4221 to a distal position from the cam device 5.

Preferably, the lever element 60 is pneumatically movable.

Preferably, in the absence of a pneumatic supply, the lever element 60 is placeable in said safety position.

According to a preferred embodiment, the control group 5 controls the continuous movement of the cam device 50. Preferably, the action, or lack of action, of the safety group 6, enables, or does not enable, the movement of the blade devices 4.

One object of the present invention is a blister packaging machine comprising a conveyor belt and an unloading system 1, according to the features described above, that is suitable for performing a singularized unloading operation of a blister 90 onto said conveyor belt.

Preferably, the blister packaging machine comprises a plurality of conveyor belts suitable for operating in parallel and a plurality of unloading systems 1, wherein each unloading system 1 is suitable for performing a singularized unloading operation of a blister 90 onto a respective conveyor belt.

According to a preferred embodiment, the blister packaging machine comprises system control means engaging the control groups 5 of the respective unloading systems 1 to control them to move in unison.

Innovatively, the unloading system and the blister packaging machine that comprises it amply fulfill the intended objective, overcoming the typical issues of the prior art.

Advantageously, in fact, the unloading system enables the achievement of all industry desires in being suitable for performing timely and precise singularized unloading operations of blisters.

Advantageously, the unloading system performs the unloading of a blister, holding the subsequent blister which therefore does not burden, with its presence and force of weight, the blister being unloaded.

Advantageously, the unloading system performs precise, guided and safe blister movements.

Advantageously, the control of the descent of the blisters is timely and certain.

Advantageously, the control of the descent of the blisters is not influenced by the number of blisters within the column of blisters.

Advantageously, the unloading system controls both the singularized unloading of the last blister and the second-last blister.

Advantageously, the unloading system performs identically reproducible movements over time.

Advantageously, the unloading system performs movements with elevated precision thereby ensuring the positioning of the respective blade devices.

Advantageously, the unloading system is extremely flexible: it is in fact extremely simple to adapt the unloading system according to different types of blister packs, for example by modifying or replacing the blade element and/or the position thereof according to the shape of the blister.

Advantageously, the unloading system ensures elevated unloading speed, being suitable for performing singularized unloading operations with a periodicity of between 0.2 and 0.5 seconds, preferably 0.3 seconds.

Advantageously, the unloading system includes a safety group by means of which, in the case of a possible failure, the blisters s are held. Advantageously, the safety group avoids the undesired unloading of a blister.

Advantageously, the safety group includes a double safety measure: in the case of a malfunction or failure it is placed in a safety position.

Advantageously, the action of the control group is continuous.

Advantageously, the machine may be designed according to requirements, taking advantage of the design versatility of the unloading system.

It is clear that a person skilled in the art may make changes to the invention described above in order to meet contingent needs, which changes all fall within the scope of protection as defined in the following claims.

1. An unloading system (1) suitable for performing a singularized unloading operation of a blister (90), for example onto a conveyor belt, comprising:
a blister storage column (2) extending along a vertical axis (V-V) in which a column of blisters (900) comprising a plurality of blisters (90) that are vertically stacked, each parallel to a respective imaginary plane, is housable, wherein the blister storage column (2) comprises a bottom region (20) in which the column of blisters (900) comprises a last blister (90a) and a second-last blister (90b) ;
ii) a pair of unloading assemblies (3) extending and operating transversely opposed with respect to the vertical axis (V-V), wherein each unloading assembly (3) comprises:
a plurality of blade groups (4), at least two blade groups (41, 42), movable transversely along a transverse axis (X-X), each suitable for engaging a respective blister (90) starting from the last blister (90a) and the second-last blister (90b), wherein each blade group (4) comprises a movement device (412, 422) and a blade element (411, 421) suitable for engaging a blister and engaged with an end of the respective movement device (412, 422);
a control group (5) operatively connected to the respective ends of the movement devices (412, 422), comprising a cam device (50) which alternately transversely moves the movement devices (412, 422) SO that, in two vertically consecutive blade groups (4), one blade element (411, 421) is disengaged from a blister which is thus free to fall vertically, while the other blade element (411, 421) engages and holds the consecutive blister in a respective vertical axial position, and vice versa.

2. Unloading system (1) according to claim 1, wherein the pair of unloading assemblies (3) is configurable in a blister unloading configuration, in which the last blister (90a) is free to fall while the second-last blister (90b) is held in a respective vertical axial position, and a blister holding configuration, in which the last blister (90a) is held in a respective vertical axial position while the second-last blister (90b) is free to fall.

3. Unloading system (1) according to any one of the preceding claims, wherein each movement device (412, 422) comprises a rod element (4121, 4221) comprising a first end integrally connected to the respective blade element (411, 421) and a second end which is engageable with the cam device (50) to receive the transverse thrust action, and an elastically yielding element (4125, 4225) suitable for performing a transverse thrust action on the rod element (4121, 4221) to keep it engaged with the cam device (50).

4. Unloading system (1) according to claim 3, wherein each rod element (4121, 4221) comprises a wheel member (4121′, 4221′) suitable for engaging the cam device (50).

5. Unloading system (1) according to any one of the preceding claims, wherein the cam device (50) comprises a plurality of cam members (51, 52) each operatively connected to the respective movement device (412, 422), wherein the respective cam profiles are suitable for alternately moving the movement devices (412, 422).

6. Unloading system (1) according to claim 5, wherein the cam members (51, 52) are controlled to rotate with respect to the same rotation axis (R-R).

7. Unloading system (1) according to any one of the preceding claims, wherein the two control groups (5), each of a respective unloading assembly (3), operate synchronously on the respective blade groups (4) by means of a drive element suitable for connecting them, such as a belt or chain.

8. Unloading system (1) according to any one of the preceding claims, wherein each unloading assembly (3) comprises a safety group (6) suitable for disengaging at least one blade group (4), preferably the blade group operating on the last blister (90a), from the control group (5) to position it in a transverse position in which it engages the blister.

9. Unloading system (1) according to claim 8 in combination with claim 3, wherein said safety group (6) comprises a lever element (60) placeable in a safety position in which the action of the elastically yielding element (4125, 4225) is overcome so as to transversely move the rod element (4121, 4221) to a distal position from the cam device (5).

10. Unloading system (1) according to claim 9, wherein the lever element (60) is pneumatically movable and, in the absence of pneumatic supply, is placeable in said safety position.

11. Unloading system (1) according to any one of the preceding claims 8 to 10, wherein the control group (5) controls the cam device (50) to continuously move.

12. A blister packaging machine comprising a conveyor belt and an unloading system (1) according to any one of the preceding claims, suitable for performing a singularized unloading operation of a blister (90) onto said conveyor belt.

13. Blister packaging machine according to claim 12, comprising a plurality of conveyor belts suitable for operating in parallel and a plurality of unloading systems (1), wherein each unloading system (1) is suitable for performing a singularized unloading operation of a blister (90) onto a respective conveyor belt.

14. Blister packaging machine according to claim 13, comprising system control means engaging the control groups (5) of the respective unloading systems (1) to control them to move in unison.
